(19) United States
(12) Patent Application Publication
(10) Pub. No.: US 2014/0286009 A1
(43) Pub. Date: Sep. 25, 2014

(54) MODULAR SOLID STATE ELECTRONIC DISPLAY PANELS WITH ELECTROMAGNETIC RADIATION SHIELDING

(71) Applicant: BILLBOARD VIDEO, INC., Corona, CA (US)

(72) Inventors: Scott Hamilton, San Clemente, CA (US); Stanley Warwarick, Sacramento, CA (US)

(73) Assignee: BILLBOARD VIDEO, INC., Corona, CA (US)

(21) Appl. No.: 13/848,997

(22) Filed: Mar. 22, 2013

(51) Int. Cl. F21V 23/00

(52) U.S. Cl. CPC F21V 23/00
USPC 362/249.02

(57) ABSTRACT

A display module having electromagnetic interference shielding is disclosed. The display module has a mask circuit board disposed immediately above a first circuit board. One or more light emitting elements are disposed on a top surface of the first circuit board. The mask circuit board has one or more apertures which enable the light from the light emitting elements to radiate outward. The mask circuit board has one or more metalized layers electrically connected to ground which receive and reduces the electromagnetic radiation emitted from the first circuit board. The display module employs one or more shield strips disposed near the perimeter of the mask circuit board and first circuit board to receive and reduce the electromagnetic radiation which would otherwise radiate laterally from the circuit boards.

### BACKGROUND OF THE INVENTION

1. Field of the Invention

The present invention relates in general to electronic display panels. More particularly, the invention is directed to solid state display panels having reduced electromagnetic interference radiation.

2. Description of the Related Art

Dynamic solid state displays are employed in many applications such as in outdoor billboards, entertainment venues, and theaters. Such displays may be formed using interconnected modular panels each having an array of display elements. However, these displays may emit excessive electromagnetic radiation in violation of emission standards. Conventional approaches to reduce the electromagnetic interference radiation may detrimentally affect the transmission of light from display elements.

Accordingly, a need exists to provide modular solid state electronic panels having improved electromagnetic interfere shielding.

### SUMMARY OF THE INVENTION

In the first aspect, a display module comprises an LED circuit board having an array of LED packages on a first surface, and a mask circuit board having an array of apertures sized and spaced to receive the array of LED packages, the mask circuit board disposed above and apart from the first surface of the LED circuit board, the mask circuit board having at least one metalized surface.

In a first preferred embodiment of the display module, the mask circuit board further comprises two metalized surfaces on opposite sides of the mask circuit board and a plurality of mask circuit board through-holes electrically coupling the two metalized surfaces. The LED circuit board preferably further comprises a plurality of LED circuit board through-holes each disposed immediately below a corresponding mask circuit board through-hole. The display module further comprises a plurality of metal connector pins each having a top pin section and a bottom pin section, the top pin section disposed within a mask circuit board through-hole and the bottom pin section disposed within a corresponding LED circuit board through-hole, the connector pins electrically coupling the LED circuit board and the mask circuit board. The connector pin preferably further comprises a sleeve disposed between the top pin section and the bottom pin section, the sleeve coupled to the mask circuit board providing mechanical support. The two metalized surfaces on mask circuit board are preferably formed with copper. The display module preferably further comprises a plurality of thin shield strips disposed along the perimeter of and extending beyond the mask circuit board, the shield strips electrically coupled to the metalized surface of the mask circuit board. The shield strips preferably comprises a plurality of spaced metal tabs, each of the tabs having a first section adjacent to the mask circuit board and a second section connected to the first section distal to the mask circuit board, the first section emerging from the mask circuit board forming a bevel and having a first outward, obtuse angle with respect to the mask circuit board, the second section bending inward toward the LED circuit board having a second obtuse angle. The shield strips are preferably surface-mount soldered onto the mask circuit board. The shield strips are preferably formed from bright tin beryllium copper.

In a second aspect, a display module comprises a first circuit board having one or more light emitting elements on a top surface of the first circuit board, and a mask circuit board stacked above the top surface of the first circuit board, the mask circuit board having a size and shape of that of the first circuit board, the mask circuit board having a metalized top exposed surface and a metalized inner surface immediately above the top surface of the first circuit board. The display module further comprises a plurality of shield strips disposed around and away from the perimeter of the first circuit board, the shield strips essentially surrounding a gap between the first circuit board and the mask circuit board.

In a second preferred embodiment, the shield strips further comprise an elongated metal sheet twice folded along the length of the sheet forming a mounting section, a first section, and a second section, the first section extending from the mounting section at a first obtuse angle, the second section extending from the first section at a second obtuse angle. The mounting section of the shield strips are preferably coupled to the perimeters of the inner surface of the mask circuit board, and the first and second sections extend generally toward the first circuit board, the first and the second sections each having portions laterally disposed beyond the edge of the mask circuit board. The second and third sections preferably have spaced notches to form a series of tabs. The shield strips are preferably formed in bright tin beryllium copper. The light emitting devices preferably comprise light emitting diodes.

In a third aspect, a display module system comprises a plurality of display modules each having an array of light emitting devices, said each of the display modules having a plurality of shield strips surrounding and extending away laterally from said each display module, said each display module forming electrical contacts with at least one adjacent LED display module.

In a third preferred embodiment, each of the display modules further comprises an LED circuit board having the array of LED packages mounted on a first surface, and a mask circuit board having an array of apertures sized and spaced to receive the array of LED packages, the mask circuit board having an internal surface immediately above the first surface of the LED circuit board. The shield strips are preferably mounted to the internal surface of the mask circuit board. Each of the shield strips preferably comprises a mounting section and a plurality of metal tabs spaced along the perimeter of the mask circuit board having a first and second section, the mounting section disposed on the mask circuit board, the first section emerging from the mounting section forming a bevel and having a first outward, obtuse angle with respect to the mask circuit board, the second section bending inward toward the LED circuit board forming a second obtuse angle. The shield strips are preferably surface-mount soldered onto the mask circuit board. The shield strips are preferably formed in bright tin beryllium copper.

These and other features and advantages of the invention will become more apparent with a description of preferred embodiments in reference to the associated drawings.

### DESCRIPTION OF THE DRAWINGS

FIG. 1 is a perspective view of an embodiment of an electronic display module.

FIG. 2 is a perspective view of an embodiment of an electronic display module showing a LED circuit board, a mask circuit board, and shield strips.

FIG. 3 is an exploded, perspective view of an embodiment of the electronic display module showing assembly details of the display module components.

FIG. 4 is a cross-sectional view of the LED package mounted on the LED circuit board extending through apertures in the mask circuit board.

FIG. 5 is a cross-sectional view of a connector pin coupled to the LED circuit board and the mask circuit board.

FIG. 6 is a lower perspective view of an embodiment of the electronic display module showing the shield strips surrounding the LED circuit board.

FIG. 7 is a perspective view of the shield strips mounted on the inner surface of the mask circuit board.

FIG. 8 is a cross-sectional view of a shield strip mounted near the edge of the mask circuit board.

FIG. 9 is a cross-sectional view of two electronic display modules electrically coupled by the shield strips.

FIG. 10 is a perspective view of a display module system in an exemplary embodiment.

### DETAILED DESCRIPTION OF THE PREFERRED EMBODIMENTS

The following preferred embodiments are directed to electronic display modules and systems employing electromagnetic interference (“EMI”) shielding. Large display module systems may be formed from arrays of individual electronic display modules. The display module systems may be used in applications such as digital billboards, digital signage, and dynamic displays providing video. The display modules employ EMI shielding to reduce the unwanted electromagnetic radiation emitted by the display modules which may otherwise detrimentally interfere with other communication devices.

Within this disclosure, reference is made to light emitting diodes (“LEDs”), LED packages, and LED circuit boards as specific examples of one or more preferred embodiments. This, however, should not be taken as being limiting in nature as other display technologies, such as, but not limited to, liquid crystal displays, plasma displays, and other solid state displays may be contemplated in one or more embodiments.

In one or more embodiments, the display module has a first circuit board having light emitting elements and a mask circuit board which serves to reduce the electromagnetic radiation emitted by the first circuit board. In an embodiment, the mask circuit board is disposed immediately above the first circuit board. One or more light emitting elements are disposed on a top surface of the first circuit board. The mask circuit board has one or more apertures which enable the light from the light emitting elements to radiate outward. The mask circuit board has one or more metalized layers electrically connected to ground or other current or potential sinks which receive and reduces the electromagnetic radiation emitted by the first circuit board from radiating beyond the mask circuit board.

In one or more embodiments, the display module employs one or more shield strips disposed near the perimeter of the mask circuit board and the first circuit board to receive and reduce the electromagnetic radiation which would otherwise radiate laterally from the circuit boards. In a preferred embodiment, the shield strips extend slightly beyond the circuit boards to make contact with shield strips on adjacent display modules to provide a path to electrical ground.

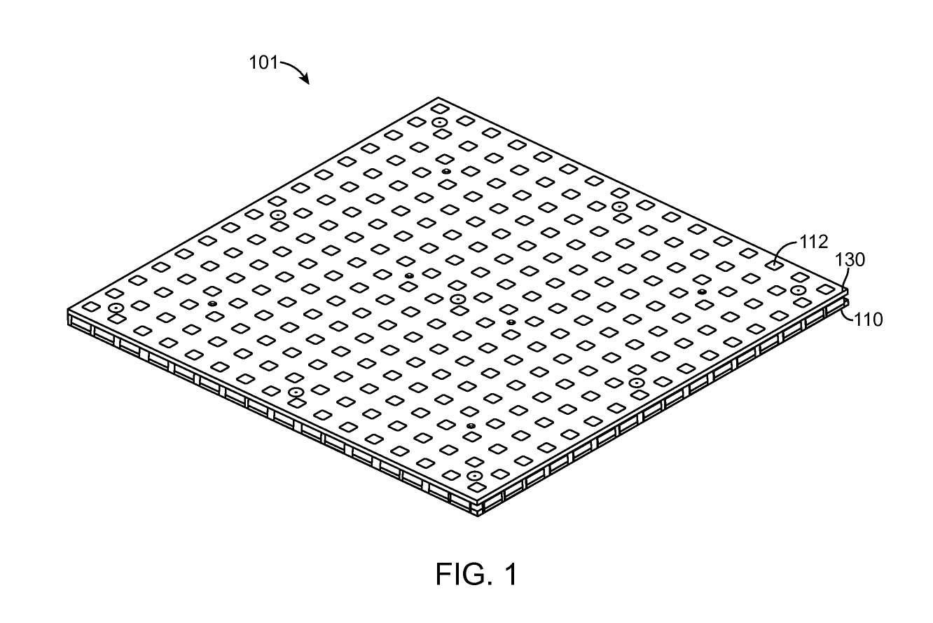

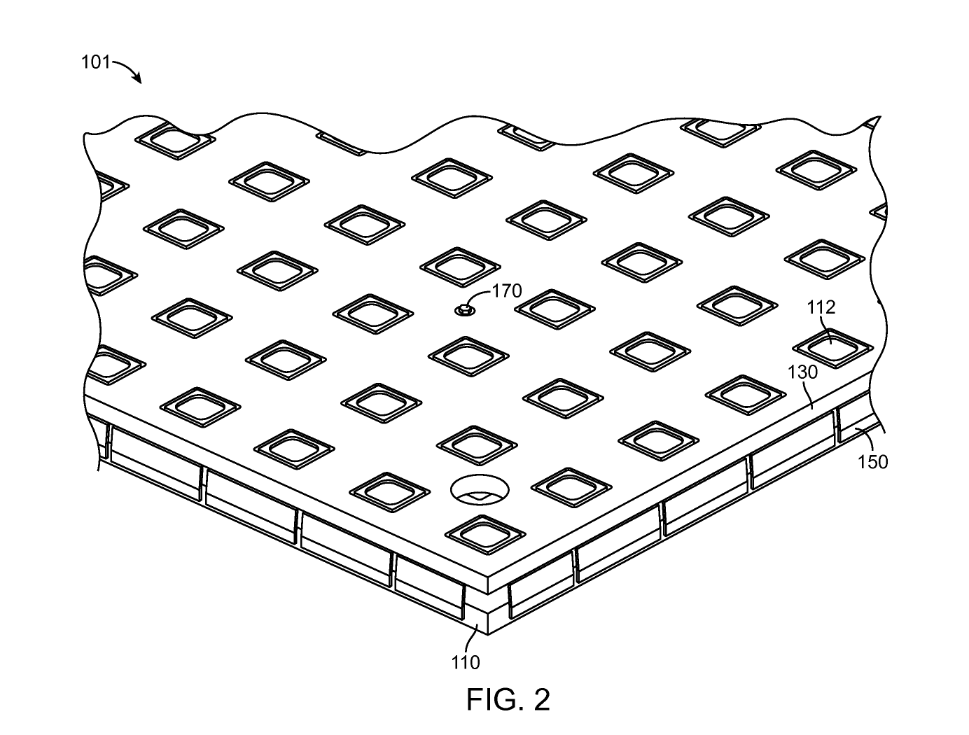

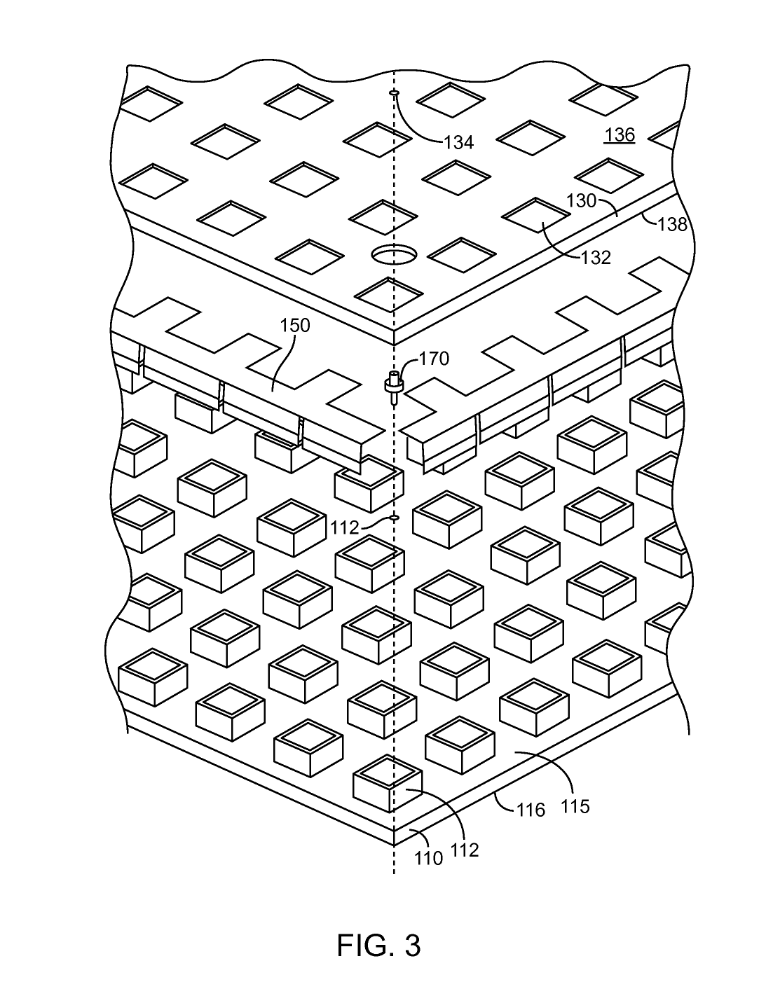

FIGS. 1 and 2 are perspective views of an embodiment of an exemplary electronic display module 101. FIG. 3 presents an exploded view of the display module 101 showing the inner features of the display module 101. The display module 101 has an LED circuit board 110 (i.e., the first circuit board) and a mask circuit board 130 disposed above and apart from the top surface 115 (i.e., first surface) of the LED circuit board 110. The LED circuit board 110 may be a rigid glass-reinforced multilayer printed circuit board assemble (“PCBA”) with the LED packages 112 on the top surface 115 and support circuitry on the bottom surface 116. The LED circuit board 110 has an array of LED packages 112 on the top surface 115. The LED packages 112 may be single or multicolor light emitting diodes having red, green, and blue light emitting diodes. The LED packages 112 may be either surface mounted or through-hole mounted to the LED circuit board 110.

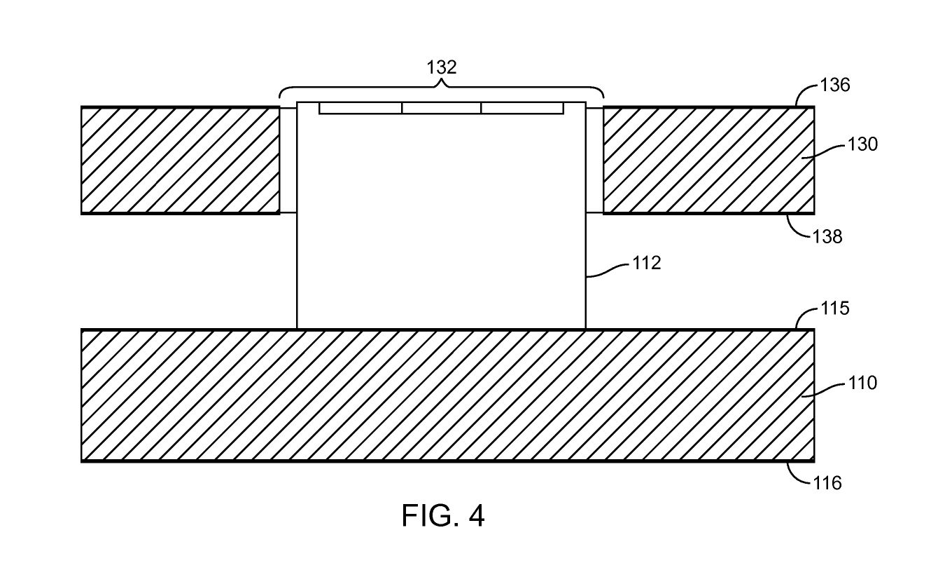

As shown in FIG. 4, the mask circuit board 130 has an array of apertures 132 which may be sized and spaced to receive the array of LED packages 112. The mask circuit board 130 may be positioned essentially flush with the top of the LED packages 112, or may be placed below or above the top of the LED packages 112. The height of LED package 112 above or below the top of mask circuit board may be critical for the ability to view the display. For example, if the top of the LED package 112 is too far below the mask circuit board 130, the viewing angle of the LED package 112 may decrease. On the other hand, if the top of the LED package 112 is too far above the mask circuit board 130, the sides and leads of the LED package 112 may become visible.

The mask circuit board 130 has at least one metalized surface such as the first mask surface 136 or the second mask surface 138. The mask circuit board 130 may be a rigid glass-reinforced high temperature epoxy substrate with one or two surfaces clad and plated with copper.

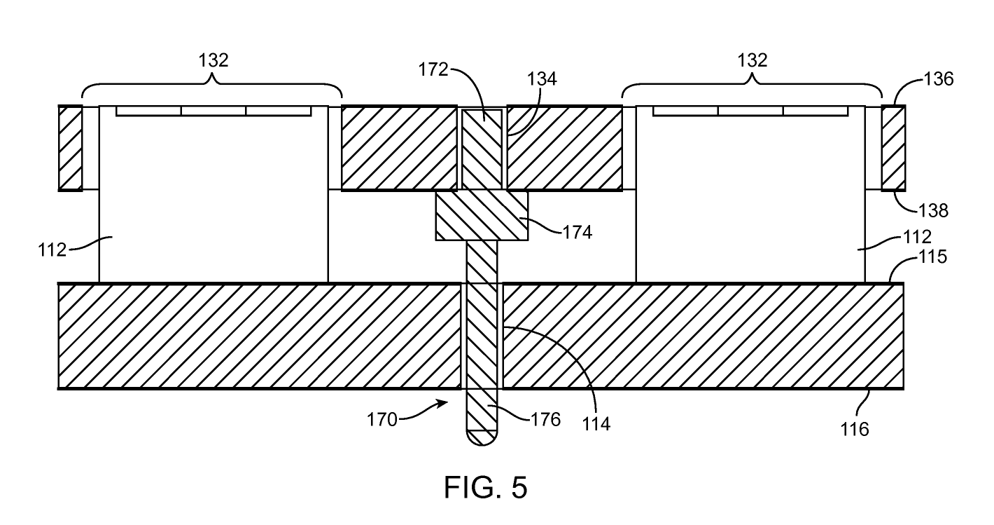

As shown in FIG. 5, the mask circuit board 130 may have plated mask circuit board through-holes 134 to form an electrical connection between the first surface 136 and the second surface 138 of the mask circuit board 130. The two metalized surfaces 136 and 138 on mask circuit board 130 may be formed with copper. The LED circuit board 110 may have one or more metalized surfaces such as top surface 115 and bottom surface 116 as well as a plurality of LED circuit board through-holes 114 which electrically couples the top surface 115 and the bottom surface 116. In an embodiment, the LED circuit board through-holes 114 are formed immediately below and aligned with the mask circuit board through-holes 134.

A connector pin 170 may be employed to provide mechanical support and electrical coupling between the mask circuit board 130 and the LED circuit board 110. The connector pin 170 may have a top pin section 172 and a bottom pin section 176, the top pin section 172 may be disposed within a mask circuit board through-hole 134 and the bottom pin section 176 is disposed within the corresponding LED circuit board through-hole 114. The connector pin 170 electrically couples the LED circuit board 110 and the mask circuit board 130. The connector pin 170 may have a sleeve 174 disposed between the top pin section 172 and the bottom pin section 176. The sleeve 174 may be coupled to the mask circuit board 130 to provide mechanical support. The connector pin 170 may be formed in brass such as brass meeting the ASTM-B16 standard. The connector pin 170 may be plated with gold or tin.

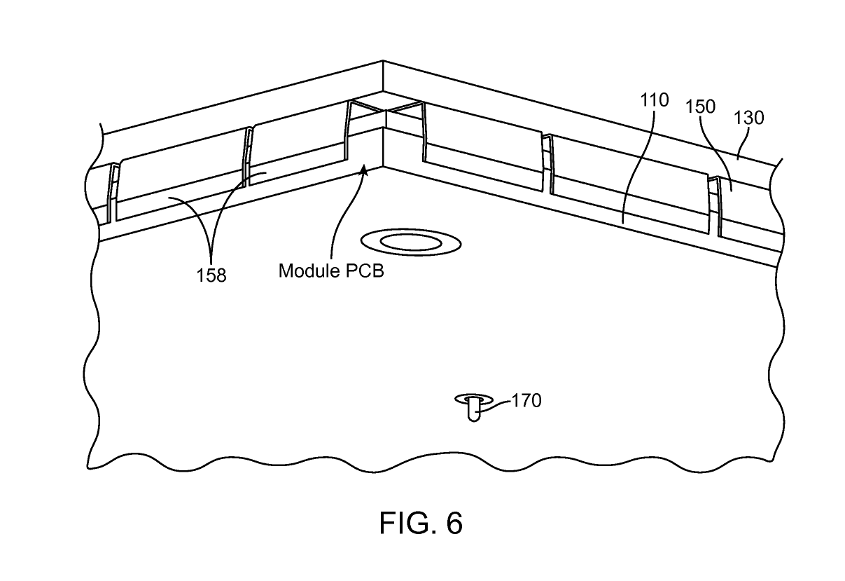

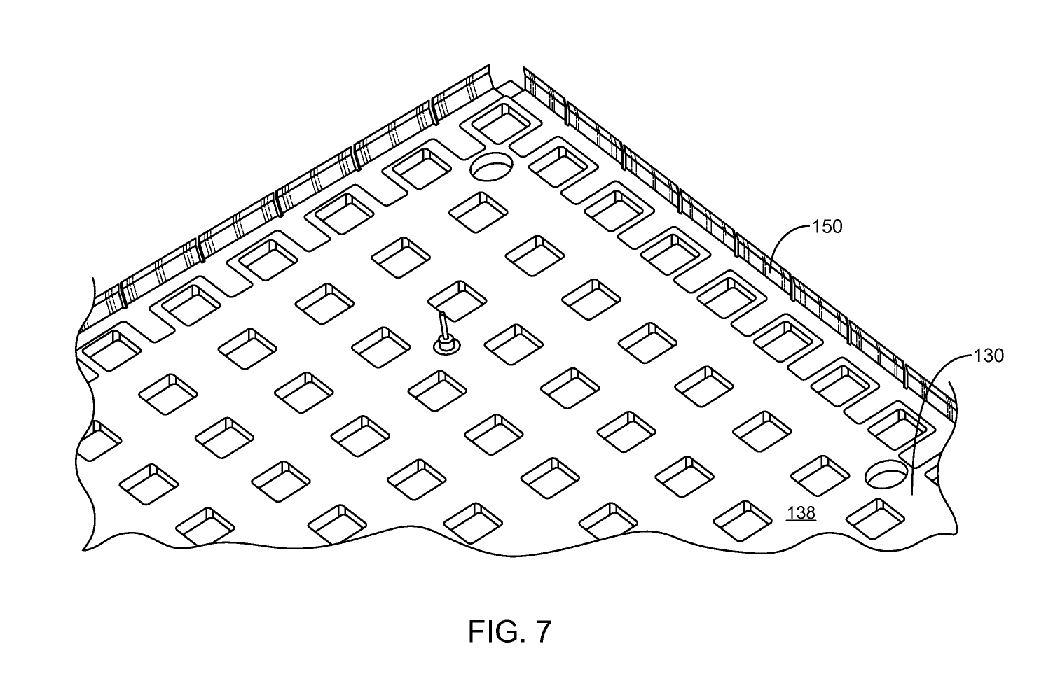

As shown in FIGS. 6 and 7, the display module 101 may have a plurality of thin shield strips 150 disposed along the perimeter of and extending beyond the mask circuit board 130 such that the shield strips 130 essentially surround the gap between the mask circuit board 130 and the LED circuit board 110. The shield strips 150 may be electrically coupled to a metalized surface such as the first surface 136 or the second surface 138 of the mask circuit board 130. The shield strips 150 are preferably formed from bright tin beryllium copper.

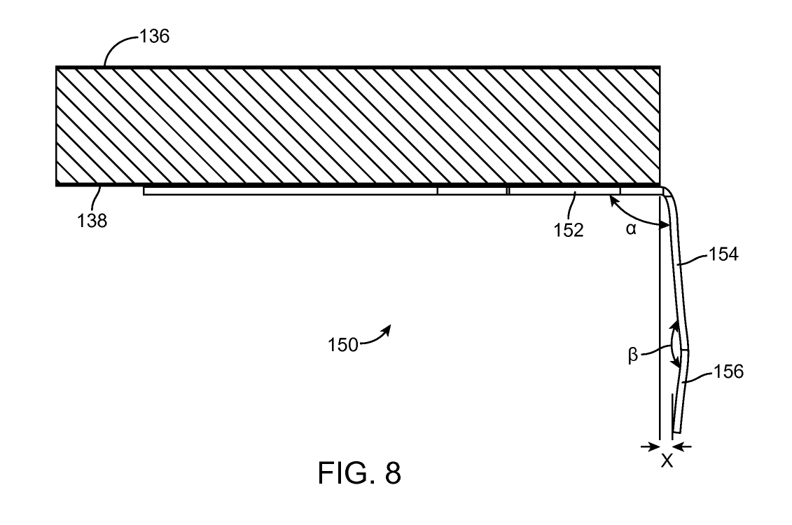

Referring to FIG. 8, the shield strips 150 may be shaped to have a mounting section 152, a first section 154, and a second section 156. The mounting section 152 may be surface mounted onto the second surface 138 of the mask circuit board 130 for example. The mounting section 152 extends along the perimeter of the of the mask circuit board 130 and may partially extend inward between adjacent apertures 132 of the mask circuit board 130 as shown in FIG. 7.

The first section 154 is connected to the mounting section 152 and emerges from the mask circuit board 130 forming a bevel and having an outward, obtuse angle α with respect to the first section 152. The second section 156 is connected to the first section 154 distal to the mounting section 152 and bends inward with a second obtuse angle β. In an embodiment, the angle α is approximately 95 degrees and the angle β is approximately 170 degrees. The inner surface of the first section 154 and the second section 156 is laterally displaced from the edge of the mask circuit board 130 as represented by the dimension “x.” In an embodiment, the shield strips 150 may be formed from an elongated metal sheet twice folded along the length of the sheet forming the mounting section 152, the first section 154, and the second section 156.

The distance of the shield strip 150 relative to the LED circuit board 110 is considered. If the shield strip 130 extends too far below the LED circuit board 110, issues related to the shield strips 130 interfering with electronics mounted on the bottom surface 116 may be raised. If the end of the shield strips 130 end too far above the LED circuit board 110, issues related to the assembly of the mask circuit board 130 to the LED circuit board may be raised.

Referring to FIG. 6, first section 154 and the second section 156 may be notched to form a plurality of spaced metal tabs 158. Such tabs 158 may flex individually in response to localized lateral forces which may improve physical contact and electrical conductivity between adjacent display modules 101.

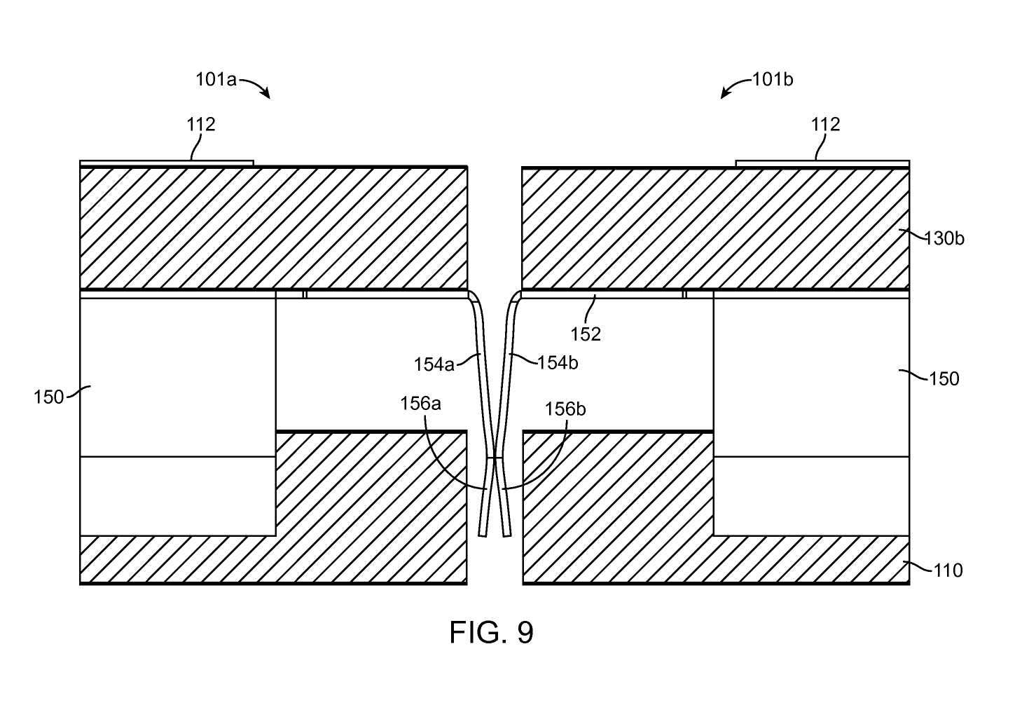

FIG. 9 is a cross sectional view of two adjacent display modules 101a and 101b. As discussed above, portions of the first section 154 and the second section 156 extend laterally away from the edges of the mask circuit board 130 and the LED circuit board 110. As such, the shield strips 150a and 150b of the adjacent display modules 101a and 101b form an electrical contact between adjacent display module.

In an embodiment, the size and shape of the mask circuit board 130 is the same as that of the LED circuit board 110. Hence, the lateral displacement (i.e., “x” in FIG. 8) will automatically be present as a result of placing the shield strips 150 at the edge of the mask circuit board 130. Moreover, the edge of the LED circuit board 110 also limits the total amount of deflection the first section 154 and the second section 156 will undergo as a result of physical contact with adjacent display modules 101.

The interference or physical and electrical contact between shield strips 150 of adjacent display modules such as display modules 101a and 101b may ensure proper electrical connection with low contact resistance. Too little physical and electrical contact will increase the contact resistance and decrease shielding effectiveness. On the other hand, too much interference will cause difficulties in assembly and service as well as possible damage to the shield strips. This parameter is dependent on several other independent variables and dimensions. Each of these independent variables has a wide range of possible values, each of which is only critical for shielding performance as it relates to the contact between adjacent modules' shield strips.

The gap between adjacent LED modules 101a-101d ensures proper electrical connection with low contact resistance, and creates a seamless visual plane. A gap too large will allow the distinct modules to become visible and detract from the ability to view the display. The contact resistance depends on the finish and wear resistance of the shield strips 150 as well as the soldered connection of the LED circuit board 110 and the mask circuit board 110 to the connector pin 170.

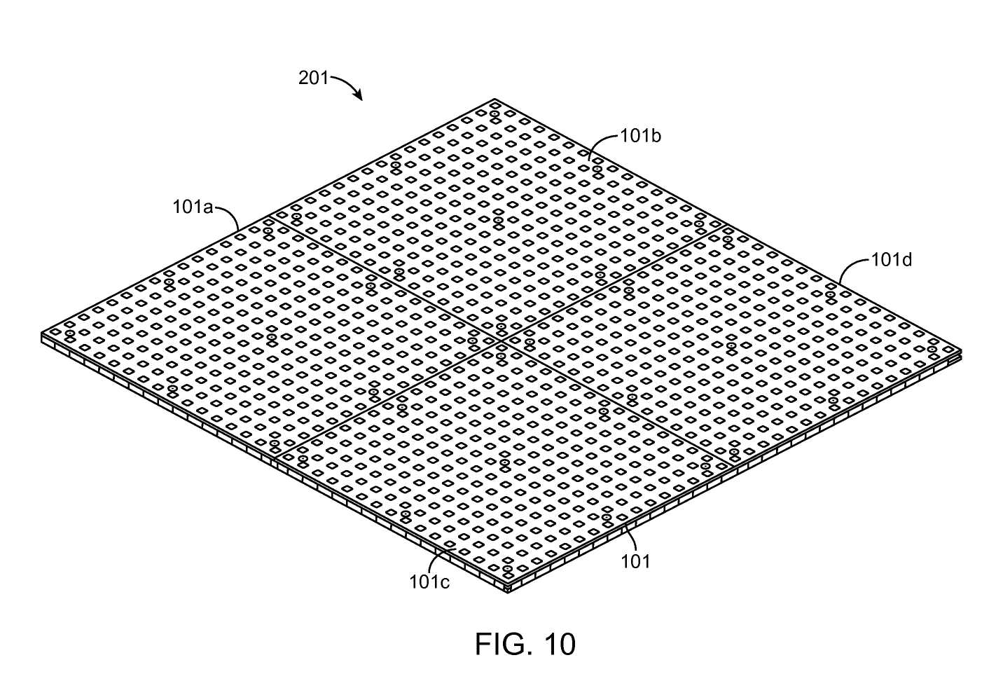

FIG. 10 is a perspective view of a display module system 201 having a plurality of display modules 101a-101d. As discussed above, the display modules 101a-101d each have an array of light emitting devices 112 and a plurality of shield strips 150 surrounding and extending away laterally from each display module 101a-101d. Each display module 101a-101d form an electrical contact with at least one adjacent LED display module as a result of placing the display modules 101.

The display module 101 which may be used to form a display module system 201 may have several benefits. First, because each display module 101 has integrated EMI shielding, and the shields are small, there is no tolerance stack-up or thermal expansion considerations across a large single shield. The small size makes the base of possible manufacturers larger. Second, the display modules 101 have greater ease of installation and maintenance because the shielding and connection to adjacent shields are built into one modular assembly which can easily be removed and/or replaced by factory or field service personnel with standard tools. There is no special alignment required between adjacent display modules 101. Third, the display module 101 is readily scalable. Because of size, ease of installation, and contiguous nature of the shielding, additional display modules 101 can be easily added to increase the size as there is no practical size limit to this method.

Moreover, the ability to use a metalized mask circuit board 130 improves the contrast of the display. The metalized mask circuit board 130 may have a high-contrast matte finish coating applied. Because the mask circuit board 130 is designed to cover most of the area between the LED packages 112, the mask circuit board 130 blocks the visibility of the metal leads and white sides of the LED package 112 as well as the metal pads on the LED circuit board.

Other distinguishing features of the display module 101 include the shield strip 150 on adjacent removable display modules 101 to create a tiled continuous surface. The shield strips 150 are surface-mount soldered onto the mask circuit board 130 for good electrical connection and to allow the shield strip 150 to be installed completely from the non-visible side of the mask circuit board 130. Shield strips 150 of this type are typically mechanically fastened with clip features, double-sided adhesive tape, or rivets, for example. With a clip or rivet, for example, part of the strip would be visible on the top side; this would decrease the ability to view the display. A soldered attachment is also stronger than a double-sided adhesive mount. Conventional approaches for most existing strips are designed for use between a fixed piece and a removable piece, for example, a door on an enclosure.

Although the invention has been discussed with reference to specific embodiments, it is apparent and should be understood that the concept can be otherwise embodied to achieve the advantages discussed. The preferred embodiments above have been described primarily as modular solid state display panels having reduced EMI radiation. In this regard, the foregoing description of the display module is presented for purposes of illustration and description. Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

What is claimed is:

1. A display module, comprising:
an LED circuit board having an array of LED packages on a first surface; and,
a mask circuit board having an array of apertures sized and spaced to receive the array of LED packages, the mask circuit board disposed above and apart from the first surface of the LED circuit board, the mask circuit board having at least one metalized surface.

2. A display module of claim 1, wherein:
the mask circuit board further comprises two metalized surfaces on opposite sides of the mask circuit board and a plurality of mask circuit board through-holes electrically coupling the two metalized surfaces; and
the LED circuit board further comprises a plurality of LED circuit board through-holes each disposed immediately below a corresponding mask circuit board through-hole.

3. A display module of claim 2, further comprising:
a plurality of metal connector pins each having a top pin section and a bottom pin section, the top pin section disposed within a mask circuit board through-hole and the bottom pin section disposed within a corresponding LED circuit board through-hole, the connector pins electrically coupling the LED circuit board and the mask circuit board.

4. A display module of claim 3, wherein the connector pin further comprises a sleeve disposed between the top pin section and the bottom pin section, the sleeve coupled to the mask circuit board providing mechanical support.

5. A display module of claim 6, wherein the two metalized surfaces on mask circuit board is formed with copper.

6. A display module of claim 1, further comprising a plurality of thin shield strips disposed along the perimeter of and extending beyond the mask circuit board, the shield strips electrically coupled to the metalized surface of the mask circuit board.

7. A display module of claim 6, wherein the shield strips comprises a plurality of spaced metal tabs, each of the tabs having a first section adjacent to the mask circuit board and a second section connected to the first section distal to the mask circuit board, the first section emerging from the mask circuit board forming a bevel and having a first outward, obtuse angle with respect to the mask circuit board, the second section bending inward toward the LED circuit board having a second obtuse angle.

8. A display module of claim 6, wherein the shield strips are surface-mount soldered onto the mask circuit board.

9. A display module of claim 6, wherein the shield strips are formed from bright tin beryllium copper.

10. A display module, comprising:
a first circuit board having one or more light emitting elements on a top surface of the first circuit board;
a mask circuit board stacked above the top surface of the first circuit board, the mask circuit board having a size and shape of that of the first circuit board, the mask circuit board having a metalized top exposed surface and a metalized inner surface immediately above the top surface of the first circuit board; and,
a plurality of shield strips disposed around and away from the perimeter of the first circuit board, the shield strips essentially surrounding a gap between the first circuit board and the mask circuit board.

11. A display module of claim 10, wherein the shield strips further comprise an elongated metal sheet twice folded along the length of the sheet forming a mounting section, a first section, and a second section, the first section extending from the mounting section at a first obtuse angle, the second section extending from the first section at a second obtuse angle.

12. A display module of claim 11, wherein the mounting section of the shield strips are coupled to the perimeters of the inner surface of the mask circuit board, and the first and second sections extend generally toward the first circuit board, the first and the second sections each having portions laterally disposed beyond the edge of the mask circuit board.

13. A display module of claim 12, wherein the second and third sections have spaced notches to form a series of tabs.

14. A display module of claim 10, wherein the shield strips are formed in bright tin beryllium copper.

15. A display module of claim 11, wherein the light emitting devices comprise light emitting diodes.

16. A display module system, comprising:
a plurality of display modules each having an array of light emitting devices, said each of the display modules having a plurality of shield strips surrounding and extending away laterally from said each display module, said each display module forming electrical contacts with at least one adjacent LED display module.

17. A display modular system of claim 16, wherein said each of the display modules further comprise:
an LED circuit board having the array of LED packages mounted on a first surface; and,
a mask circuit board having an array of apertures sized and spaced to receive the array of LED packages, the mask circuit board having an internal surface immediately above the first surface of the LED circuit board, wherein the shield strips are mounted to the internal surface of the mask circuit board.

18. A display modular system of claim 17, wherein said each of the shield strips comprises a mounting section and a plurality of metal tabs spaced along the perimeter of the mask circuit board having a first and second section, the mounting section disposed on the mask circuit board, the first section emerging from the mounting section forming a bevel and having a first outward, obtuse angle with respect to the mask circuit board, the second section bending inward toward the LED circuit board forming a second obtuse angle.

19. An LED display module of claim 17, wherein the shield strips are surface-mount soldered onto the mask circuit board.

20. An LED display module of claim 17, wherein the shield strips are formed in bright tin beryllium copper.
